(19) United States
(12) Patent Application Publication
(10) Pub. No.: US 2003/0103514 A1
(43) Pub. Date: Jun. 5, 2003

(54) Apparatus and method for packet scheduling using credit based round robin

(76) Inventors: Hong-Soon Nam, Daejon (KR); Man-Soo Han, Daejon (KR); Yong-Il Jun, Daejon (KR); Woo-Seop Rhee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/091,870

(22) Filed: Mar. 5, 2002

(30) Foreign Application Priority Data
Dec. 3, 2001 (KR) 01-75929

(51) Int. Cl. H04L 12/28

(52) U.S. Cl. 370/412; 370/429

(57) ABSTRACT

Disclosed herein is an apparatus and method for scheduling packets using a credit based round robin in a high-speed communication network in which packets are transmitted to and received from a plurality of connections having respective speeds of service. The scheduling apparatus includes a packet pool for storing input packets; a token queue for storing tokens each having a connection identifier (ID) of an input packet stored in said packet pool, the round number (RN) of the connection, and a credit value (CV) for service; and a connection management unit for transmitting the input packets to said packet pool, reading the packets stored in said packet pool, generating the tokens each having a connection identifier (ID) of an input packet stored in said packet pool, the round number (RN) of the connection, and a credit value (CV) for service and transmitting them to said token queue, and servicing the packets of said packet pool designated by the token stored in said token queue.

### BACKGROUND OF THE INVENTION

1. Field of the Invention

The present invention relates to an apparatus and method for packet scheduling using a credit based round robin, and more particularly to an apparatus and method for packet scheduling using a credit based round robin, in which a weight in proportion to the rate of packet transmission is previously set to as available credit, a token having a required size of credit within a range of the available credit is stored in a token queue when a packet arrives and an earliest stored token services packets of a designated connection, and to a computer readable recording medium in which a program for executing the method is recorded.

2. Description of the Prior Art

In general, a plurality of connections share restricted resources in a communication network, so temporary congestion can be caused. In this case, scheduling for providing fairness and low latency to the plurality of connections is carried out in a variety of manners.

As a conventional scheduling method, a round robin method is disclosed in U.S. Pat. No. 6,101,193. However, this method has low short time fairness and high latency, though having low time complexity. In addition, a fair queuing method is disclosed in U.S. Pat. No. 6,134,217. This method is problematic in that time complexity is increased with an increase in the number of connections due to a sorting operation accompanying the use of timestamp, though it has good fairness and good latency.

A scheduler used in high-speed communication networks should restrict the fairness and the latency and be operated at high-speed, so the time complexity should be low. For example, a packet with a length of 100 bytes has to be processed within 0.08 μsec in a 10 Gbps interface.

A deficit Round Robin (see a paper entitled “Efficient Fair Queuing Using Deficient Round Robin”, by M. Shreedhar and George Varghese, SIGCOMM '95, pp. 231-241), and a Weight Round Robin (WRR) can be implemented with the time complexity of O(1), but have low latency.

In the WRR, weight assigned to one connection can be serviced in its turn after weights assigned to other connection are serviced. A packet arriving immediately after weight assigned to one connection is serviced is serviced after weight assigned to another is serviced. If a time interval between one time and the next time serviced by its connection in the round robin is referred to as a round size, fairness and latency are dependent upon the round size. The round size is the sum of the sizes of packets for all backlogged connections equal to or less than the sum of their weights. Accordingly, the round size is closely related to the weights. Since in the weighted round robin weight W is set to be equal to or larger than the maximum packet size, the round size can be large value as the number of the connections becomes large. The sizes of packets in the Internet are various, ranging from several ten bytes to several Kbytes. Accordingly, if the weight W is set to be more than the maximum packet size, small-sized packets are serviced in a burstiness situation.

In the deficient round robin, a quantity given to one round is referred to as a quantum, which can be set to be less than the maximum packet size. A round pointer designating a packet to be serviced is serviced by the size of one quantum at its turn. Several packets of a size smaller than one quantum are serviced and packets of a size larger than one quantum are serviced with a sum of quantum of a next round until a counter value becomes equal to or larger than the size of the packets. Since the size of quantum represents a quantity to be serviced in one round for each connection, it is available to provide different rates for each connection. In other words, if a high speed connection sets a large quantum and a low rate connection sets a small quantum, a service is offered with a rate in proportion to the quantum. Since this method services a size corresponding to the quantum. When packets smaller than the size of quantum arrive, several packets are successively serviced in their sequence, resulting in an increase in burstiness. Since the quantum should be assigned in proportion to rate in order to control the bandwidth of the connection in which all packet have identical size like an ATM cell, the ATM cell is successively serviced by a size corresponding to the size of quantum, which increases a burst service.

As examples to overcome this problem, the described round robin method is proposed in U.S. Pat. No. 6,101,193, and a modified round robin method is proposed in a reference document “SRR: An O(1) Time complexity packet scheduler for flows in multi-service packet networks”, by Guo Chuanxiong, Proc. SIGCOMM '01, pp. 211-222, August 2001.

In the round robin method of the above patent, two scheduling queues being operated in a FIFO (First-In, First-Out) manner are provided and scheduling information on each HOL (Head Of Line) of the connection is stored one by one in the scheduling queues. Subsequently, when a packet arrives, it is confirmed whether it is a HOL packet. If so, the scheduling information is stored in the scheduling queues. A weight is assigned to each of the scheduling queues. The scheduling information on a packet of a value less than that of a packet counter with weight taken into account is stored in the queue being currently serviced, while the scheduling information on the packet having a value more than that of the packet counter is stored in the other queue. The scheduling queue being currently serviced continues to be serviced until it is completely empty. When backlogged scheduling information is not present in the queue, the other queue is serviced. At that time, a new round begins. In other words, when the scheduling queue being currently serviced has been completely serviced, this queue is switched to the other scheduling queue to begin a new round and a counter value of the connection serviced from the other queue is increased by weight. The two scheduling queues are serviced in a FIFO manner, and the size of the packet is compared with the counter value. If the size of the packet is less than the counter value, the scheduling queues are serviced and the counter value is decreased by a size serviced; whereas if the size of the packet is larger than the counter value, the counter value is increased by the weight and the scheduling information is stored in the scheduling queue not serviced.

However, although the described method can improve a burst service such as the round robin, there is a problem that the effect of improvement is reduced if the sizes of packets are different for connections, and repeated servicing should be performed from the scheduling queue being currently serviced to the next scheduling queue if the size of the packet is larger than the weight. The modified round robin determines the order of the connections to be serviced in advance for packets of a fixed length and services cell by cell for connection having cells backlogged in the preset order. By doing so, the fairness and the latency are good if the number of the connections (or links) is low. However, this modified round robin method has a problem that the time complexity in the process of outputting packets from queues is increased since the sequence to be serviced is increased in number with increased number of connection, and the fairness and the latency are deteriorated if the size of the packet is various.

In addition, as time stamp based scheduling methods, disclosed are self-clocked fair queuing in a reference document “A self-clocked fair queuing scheme for high-speed application”, by S. J. Golestani, Proc. INFOCOM '94, pp. 636-646, April 1994, Virtual Clock, and potential fair queuing scheme in a reference document “Efficient fair queuing algorithms for packet-switched networks”, by D. Stidialis and A. Varma, IEEE/ACM Transactions on Networking, Vol. 6, No. 2, pp. 175-185, April 1998. However, this scheduling method based on time stamp has the complexity of at least O(log(N)) in order to arrange a sequence according to time stamp though it has a good delay and a good fairness. Therefore, these methods also have a problem that since time complexity is increased with increased number of connections N, it is difficult to be applicable to a high-speed communication network having a large number of connections.

### SUMMARY OF THE INVENTION

Accordingly, the present invention has been made keeping in mind the above problems occurring in the prior art, and an object of the present invention is to provide an apparatus and method for packet scheduling using a credit based round robin in order to enhance fairness and latency by controlling service rate and servicing packets arrived according to the state of an available credit by using the available credit for each connection in networks in which a plurality of connections, each connection having different service rates, and a variety of a size of the packet are present, and a computer readable recording medium in which a program is recorded for executing the method.

In order to accomplish the above object, the present invention provides an apparatus for packet scheduling using a credit based round robin in a high-speed communication network in which packets are transmitted to and received from a plurality of connections having respective service rates, comprising: a packet pool for storing input packets; a token queue for storing tokens each having a connection identifier (ID) of an input packet stored in the packet pool, the round number (RN) of the connection, and a credit value (CV) for service; and a connection management unit for transmitting the input packets to the packet pool, reading the packets stored in the packet pool, generating the tokens each having a connection identifier (ID) of an input packet stored in the packet pool, the round number (RN) of the connection, and a credit value (CV) for service and transmitting them to the token queue, and servicing the packets of the packet pool designated by the token stored in the token queue

In addition, the present invention provides a method for packet scheduling using a credit based round robin in a high-speed communication network for receiving a plurality of packets arrived at a network switch from a plurality of the connections having a respective service rate and transmitting the packets to a communication link, comprising: a first step of setting weight (W) proportional to the service rate for each of the connections and setting the weight as available credit (AC); a second step of receiving and storing at least one input packet in a packet pool; a third step of generating and storing in a token queue a token having a connection identifier (ID) of the input packets of the connections, round number (RN) of the connection and a credit value (CV) for service, according to the result of the comparison of the size (SP) of the received input packets with the size of the available credit (AC) if the residual size (RSP) of the HOL packet of the connection received is 0; and a fourth step of servicing the stored packet designated by the token stored in the token queue.

Furthermore, the present invention provides a computer readable recording medium in which a program is recorded for executing a method for packet scheduling using a credit based round robin in a high-speed communication network in which packets are transmitted to and received from a plurality of connections having respective service rate, comprising: a first step of setting weight (W) proportional to the service rates for each of the connections and setting the weight as available credit (AC); a second step of receiving and storing at least one input packet in a packet pool; a third step of generating and storing in a token queue a token having a connection identifier (ID) of an input packet of a connection, the round number (RN) of the connection and a credit value (CV) for service, according to the result of the comparison of the size (SP) of the received input packets with the size of the available credit (AC); and a fourth step of servicing the stored packet designated by the token stored in the token queue.

According to the present invention, when the packets arrive, their scheduling information is stored in the token queue in a sequential manner based on the available credit and an arrival sequence and outputted according to the stored sequence. Also, when the packets arrive, they are stored in the packet pool, and a credit of a required size carried on the token is stored in the token queue if the available credit is present and a process is terminated if the available credit is not present. The output of packets services the HOL packet of a corresponding connection for the HOL token of the packet queue by referring to the connection identifier (ID) and the size of credit stored in the token. The HOL packet of the queue for each connection stored in the packet pool is serviced if the size of the HOL packet is equal to or less than that of the credit of the HOL token, and otherwise, the credit is added to a confirmed credit and a credit of the size of the available credit is stored again in the token queue. When the HOL packet is serviced and then the backlogged packets of the corresponding connection are present in the packet pool, a reassigned available credit of a size required is stored in the token queue. Consequently, the fairness and the latency are enhanced by controlling service rate and servicing packets arrived according to the state of an available credit by using the available credit for each connection.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing an example of a general ATM switch or router to which a packet scheduling method of the present invention is applied;

FIGS. 2a and 2b show processes of updating round robins in packet queues, wherein FIG. 2a represents a conventional process of updating a round robin in a packet queue, and FIG. 2a represents a process of updating a round robin according to an embodiment of the present invention;

FIG. 3 is a view showing a configuration of a packet scheduling apparatus according to an embodiment of the present invention;

FIG. 4 is a flowchart for explaining a packet arrival process according to the present invention;

FIG. 5 is a flowchart for explaining a packet output process according to the present invention;

FIGS. 6a and 6b are views showing the comparison of the packet services, wherein FIG. 6a shows a conventional packet service according to a weighted round robin method, FIG. 6b shows a packet service of the scheduling apparatus according to the present invention; and

FIG. 7 is a view showing an embodiment of a rate control based on a weight in the scheduling apparatus according to the present invention.

### DESCRIPTION OF THE PREFERRED EMBODIMENTS

Hereinafter, a preferred embodiment of the present invention is described in detail with reference to the accompanying drawings.

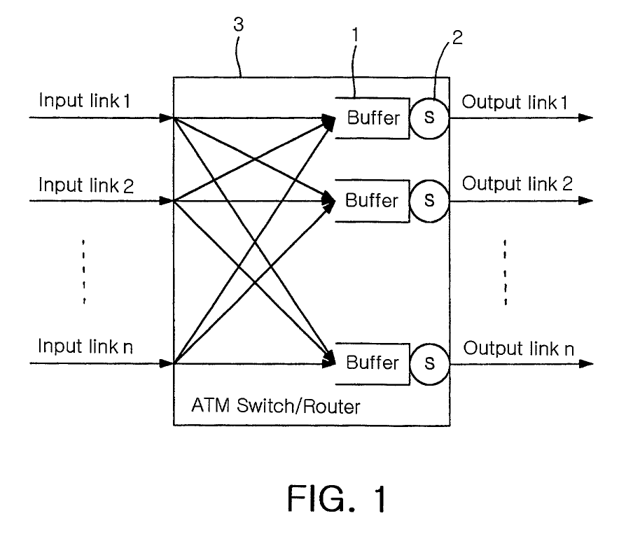

FIG. 1 shows an example of a general ATM switch or router to which a packet scheduling method of the present invention is applied. As shown in FIG. 1, an ATM switch or router 3 comprises n input links, n output links, a plurality of buffers 1 and a plurality of schedulers 2. Packets or cells inputted into the input links are transmitted to the output links via the ATM switch or router 3. In this case, since some of the packets or cells can be outputted through the same output link simultaneously, the buffers 1 and the schedulers 2 are required. That is, the buffers 1 are used to temporarily store the inputted packets to prevent the contention of the packets or cells in a single output link, and the schedulers 2 are used to service the packets queued in the buffers 1 according to a predetermined sequence or schedule with the required Quality of Service (QoS) taken into account. Typically, a number of connections (flows or sessions) share a single link, and bandwidth required by connections and the sizes of packets to be transmitted are various. Therefore, it is required to provide a scheduling apparatus and method for providing a bandwidth required by each connection and reducing latency.

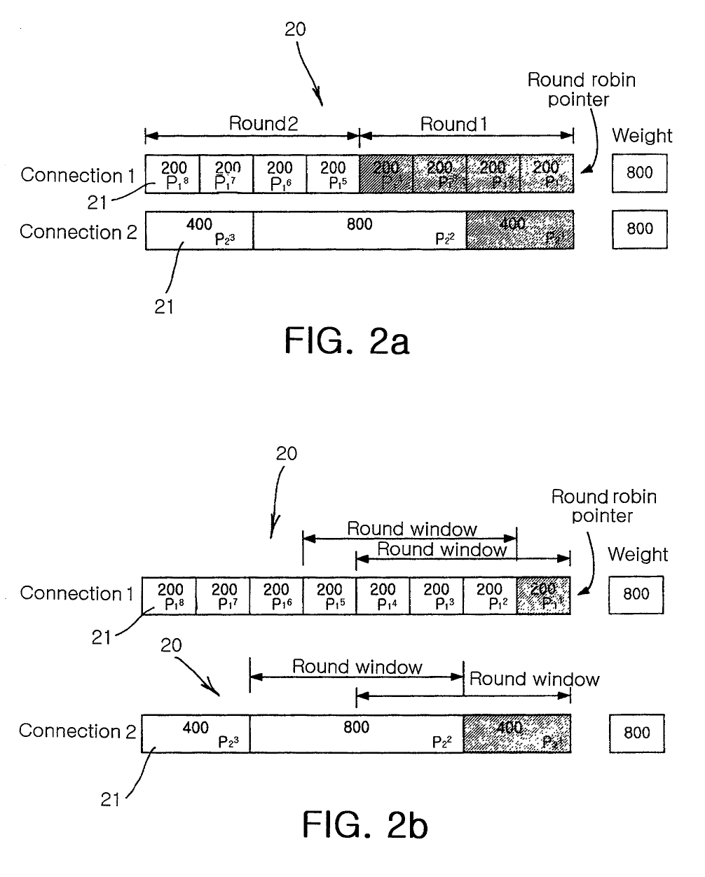

FIGS. 2a and 2b show processes of updating round robins in packet queues, wherein FIG. 2a represents a conventional process of updating a round robin in a packet queue, and FIG. 2a represents a process of updating a round robin according to an embodiment of the present invention. The packet queue 20 temporarily stores the input packets and manages them per connection until the input packets are outputted. Referring to the embodiment shown in FIG. 2b, the weight values of connections 1 and 2 are 800 each, and the packets 21 are in a backlogged state in the packet queue 20 for each connection. Each packet is represented as Pᵢ^{j}, where i refers to a connection and j refers to a j-th packet of a connection i. For example, P₁¹ represents a first packet of a connection 1 and P₂¹ represents a first packet of a connection 2. Numerals in the packets mean the size of the packet whose unit is preferably set by byte.

As shown in FIG. 2a, in the conventional round robin updating process, all backlogged connections are each serviced with packets corresponding to the weight of each corresponding connection in a current round, and then the current round is updated to the next round. For the case shown in this drawing, the weight is 800, so packets of 800 bytes can be serviced for every round. In other words, packets, P₁¹, P₁², P₁³, P₁⁴, and P₂¹ are serviced for a round 1 and the residual packets are serviced for a round 2. In this case, a round robin pointer sets a packet to be serviced. For example, as shown in FIG. 2a, if packets P₁¹ and P₂¹ arrive simultaneously, the packet P₁¹ nearer in the progress direction of the round robin pointer is first serviced.

On the other hand, as shown in FIG. 2b, in the round robin updating process of the present invention, if one packet is serviced within the range of weight, a round window is moved by that weight. Packets P₁¹ and P₂¹ are serviced, and a current round window is moved packet by packet. In this case, supposing the input and output rates of the connection 1 are equal to those of the connection 2, the packets arrive in the order of P₁¹=P₂¹>P₁²>P₁³=P₂²>P₁⁴>P₁⁵>P₁⁶>P₁⁷=P₂³>P₁⁸, where the equal symbol “=” represents simultaneous arrival.

As can be seen from the above, in the conventional weighted round robin method of FIG. 2a, the packets are serviced in the order of P₁¹>P₁²>P₁³>P₁⁴>P₂¹>P₁⁵>P₁⁶>P₁⁷>P₁⁸>P₂²>P₂³. In particular, in U.S. Pat. No. 6,101,193 mentioned above, the packets are serviced in the order of P₁¹>P₂¹>P₁²>P₁³>P₁⁴>P₂²>P₁⁵>P₁⁶>P₂³>P₁⁷>P₁⁸. However, in the round robin method of the present invention of FIG. 2b, the packets can be serviced in the order of P₁¹>P₂¹>P₁²>P₁³>P₂²>P₁⁴>P₁⁵>P₁⁶>P₁⁷>P₂³>P₁⁸.

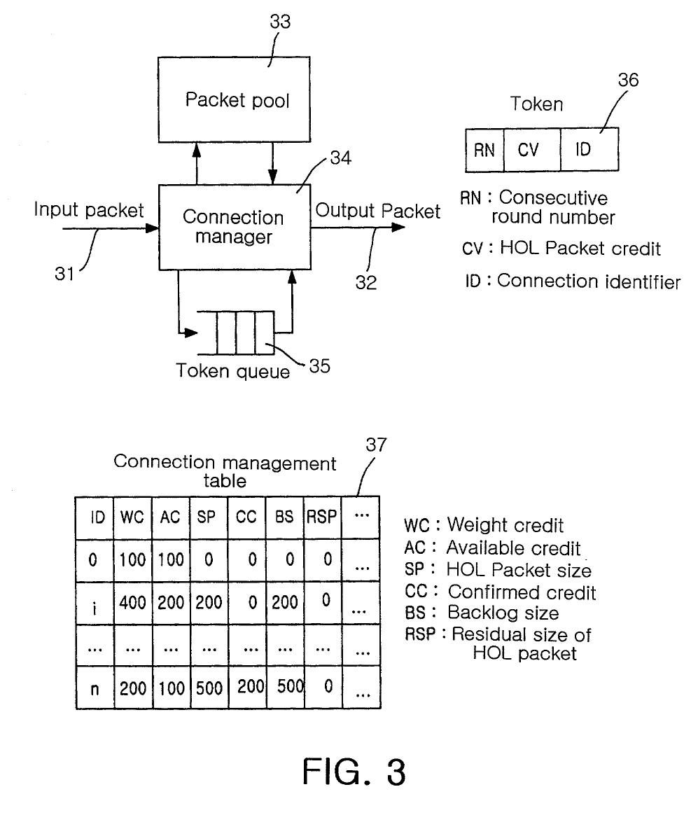

FIG. 3 is a view showing a configuration of a packet scheduling apparatus according to an embodiment of the present invention. As shown in FIG. 3, the apparatus of the present invention comprises a packet pool 33, a connection manager 34, and a token queue 35. An input packet 31 is stored in the packet pool 33 under the control of the connection manager 34, and a round number RN of a corresponding connection, a connection identifier ID and a credit value (CV) are carried on a token and stored in the token queue 35. The token queue 35 stores the token 36, and sets the order of servicing the packets stored in the packet pool 33 in a first-in, first-out (FIFO) manner, under the control of the connection manager 34.

The packet pool 33 is a place for storing packets. The packet pool 33 is preferably composed of a buffer, and is provided with queues for respective connections using techniques such as a linked list. The token queue 35 is serviced in a FIFO manner.

In addition, the connection manager 34 is provided with a connection management table 37 for respective connections. The connection manger 34 manages the processes of inputting the input packet 31, outputting the output packet 32, storing the token 36 in the token queue 35 and outputting the stored token 36. Additionally, the connection manager 34 manages the connection management table 37, which lists parameters required to schedule service for respective connections. Here, the description of the parameters is omitted.

One connection has a unique connection identifier ID or connection number, and the connection manager 34 manages a weight W, an available credit AC, the size of a HOL packet SP, a confirmed credit CC, the backlog size of a connection BS, the residual size of the HOL packet RSP, etc., for each connection.

Referring to a connection management table 37 according to an embodiment as shown in FIG. 3, information managed for respective connection IDs is stored. The weight credit WC is set to be proportional to a service rate for each connection, regardless of the size of a packet. The available credit AC represents a size usable within a weight W, and is equal to or less than the weight W (i.e., AC≦W). For example, when the weight credit WC is 400 for a connection i, a usable size, i.e., the size of the available credit AC, is 400 in an initialized state. Then, when the size of an input packet credit is 200, the size of the packet 200 is subtracted from the weight credit 400, resulting in the available credit AC 200. Therefore, the available credit reduced in size by 200 from the original available credit is set.

In addition, the size of the packet SP represents the size of the HOL packet of the connection i queuing in the packet pool 33. If the available credit AC is less than the size of the packet SP, the packet cannot be serviced using only one available credit. In this case, several available credits AC can be added to service the packet. At that time, the available credit AC is added to confirmed credit CC. The confirmed credit CC refers to credit that is unused part of the available credits AC received from the HOL token 36 of the token queue 35. If the confirmed credit CC is equal to or larger than the size of the packet SP when the confirmed credit CC is compared with the size of the HOL packet SP, the HOL packet is serviced. On the other hand, if the confirmed credit CC is larger than the size of the next HOL packet SP, the next HOL packet is serviced. Namely, if CC≧SP, the HOL packet is serviced. On the other hand, if CC<SP, the confirmed credit CC is stored and then the available credit AC of the next token 36 is waited for. The backlog size of the packet BS of the connection i represents the total size of packets of the connection i queuing in the packet pool 33. When a packet larger than the available credit AC is inputted, a difference between them is stored as the backlog size of the packet BS. Thereafter, when a packet smaller than the available credit is inputted, the backlogged packet stored as the backlog size of the packet BS is serviced.

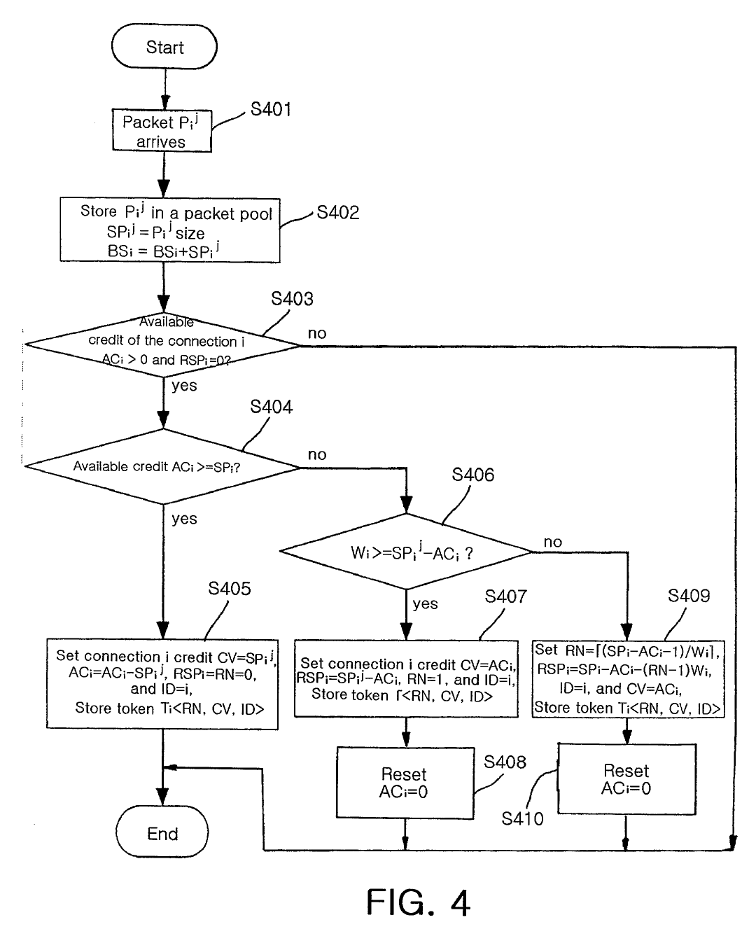

FIG. 4 is a flowchart explaining a packet arrival process according to the present invention. When the j-th packet Pᵢ^{j} of the connection i arrives at the scheduler 2 (S401), the connection manager 34 stores Pᵢ^{j} in the packet pool 33 and sets the size of the packet SPᵢ^{j} to the size of Pᵢ^{j} and the backlog size of the packet BSᵢ to BSᵢ+SPᵢ^{j} (S402). Then, the connection manager 34 determines whether an available credit ACᵢ of the connection i is 0 or whether the residual size RSPᵢ of the packet of a HOL packet is not 0 (S403) in the connection table 37. As a result of the determination at step S403, if the available credit ACᵢ of the connection i is 0 or the residual size RSPi of the packet of the HOL packet is not 0, this process is terminated. On the contrary, if the available credit ACᵢ is larger than 0 and the residual size RSPᵢ of the packet of the HOL packet is 0, the process proceeds to next step S404, where it is determined whether ACᵢ is equal to or larger than SPᵢ^{j}. As a result of the determination at step S404, if ACᵢ is equal to or larger than SPᵢ^{j}, the credit value CV of the connection i is set to the size of the packet SPᵢ^{j}, the available credit ACᵢ is set to ACᵢ−SPᵢ^{j}, the RSPᵢ and the consecutive round number RN are set to 0, the connection identifier ID is set to i, and a token T<RN, CV, ID> corresponding to the set RN, CV, ID is stored in the token queue 35 (S405). Then the process is terminated. However, as a result of the determination at step S404, if ACᵢ is smaller than SPᵢ^{j}, the process proceeds the next step S406, where it is determined whether SPᵢ^{j}−ACᵢ is equal to or smaller than Wᵢ. As a result of the determination at step S406, if SPᵢ^{j}−ACᵢ is equal to or less than Wᵢ, the credit value CV of the connection i is set to be equal to ACᵢ, the residual size of the packet RSPᵢ of the HOL packet of the connection i is set to be equal to SPᵢ^{j}−ACᵢ, RN is set to 1, ID is set to i, and a token T<RN, CV, ID> corresponding to the set RN, CV, ID is stored in the token queue 35 (S407), ACᵢ is set to 0 (S408), and then the process is terminated.

However, as the result of the determination at the step S406, if SPᵢ^{j}−ACᵢ is larger than Wᵢ, the credit value CV to be serviced by connection i is set to be equal to ACᵢ, round number RN is set to be equal to ┌(SPᵢ−ACᵢ−1)/Wᵢ┐, wherein ┌x┐ is the smallest integer value among numbers greater than x. And RSPᵢ of the connection i is set to be equal to SPᵢ−ACᵢ−(RN−1)Wᵢ, ID is set to i, the token T<RN, CV, ID> is stored in the token queue 35 (S409), ACᵢ is set to 0 (S410) and then the process is terminated.

Here, if the round number RN requires a large amount of available credit AC because the size of the packet SP is larger than the weight W, the token 36 repeats queuing several times in the token queue 35. The reason for this is to quickly determine whether to store the connection manager 34 in the token queue 35 by checking only the round number of the HOL token without referring to the connection management table 37 and store the round number in the token queue 35. In other words, if RN is more than 2, the connection manager 34 decreases RN by 1 and then stores the token in the token queue 35 without referring to values in the connection management table 37. If RN is 1, RN is reset to 0 and CV is produced with reference to RSPᵢ in the connection management table 37. If RN is 0, the packets are serviced according to the connection management table 37.

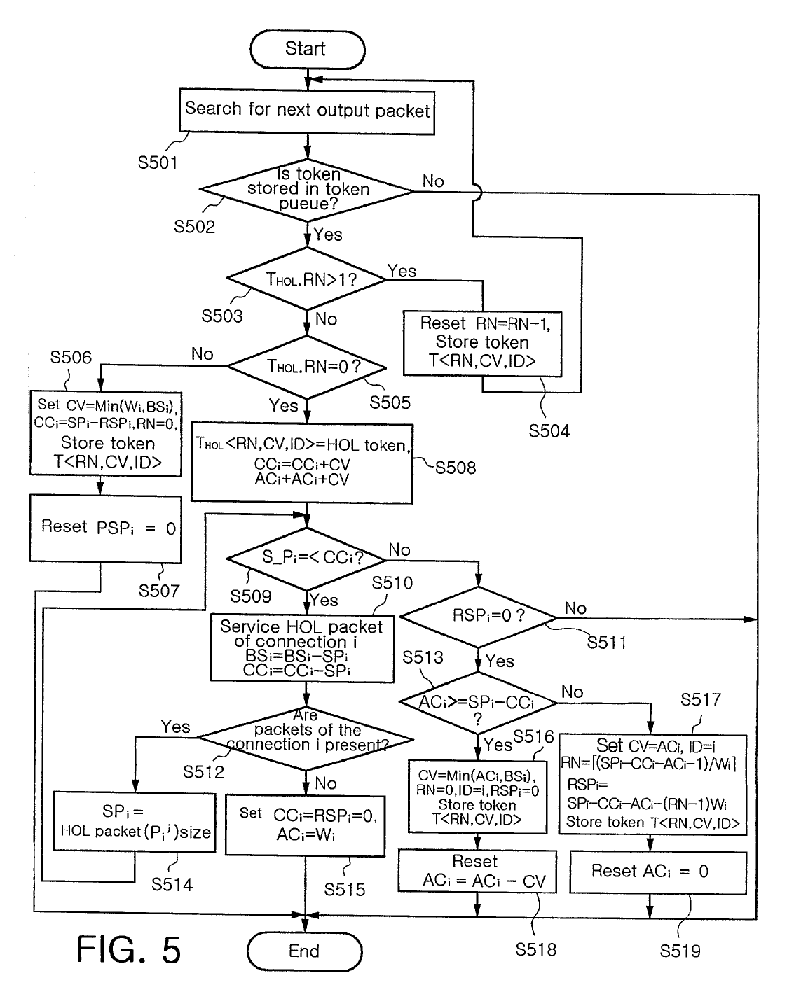

FIG. 5 is a flowchart explaining a packet output process according to the present invention. After the HOL packet of the token stored in the token queue 35 is outputted, a packet to be outputted next is searched for (S501). Then, it is confirmed whether the token 36 queuing in the token queue 35 is present (S503). As the result of the determination at the step S502, if a queuing token is not present, the process is terminated. On the contrary, if a queuing token is present, the HOL token 36 of the token queue 35 is serviced. If the HOL token is referred to as a token THOL <RN, CV, ID> and the round number of the HOL token is referred to as T_{HOL}.RN, it is determined whether T_{HOL}.RN is larger than 1 (S503). As the result of the determination at the step S503, if T_{HOL}.RN is larger than 1, the round number of the token 36 stored in the token queue 35 is decreased by 1 to be RN−1 and then the token T<RN, CV, ID> is stored in the end of the token queue 35 (S504). Then, the process returns to the step S501 to repeat the above procedure. However, as the result of the determination at the step S503, if T_{HOL}.RN is equal to or less than 1, it is determined whether T_{HOL}.RN is 0 (S505). As the result of the determination at the step S505, if T_{HOL}.RN is not 0, CV is set to min (ACᵢ, BS), CCᵢ is set to SPᵢ−RSPᵢ, RN is set to 0, and the token T<RN, CV, ID> corresponding to the set RN, CV, and ID is stored in the token queue 35 (S506). Thereafter, RSPᵢ is reset to 0 (S507) and then the process is terminated. However, as the result of the determination at the step S505, if T_{HOL}.RN is 0, the connection identifier ID of the token T_{HOL} is set to 1, CV is set to CV of T_{HOL}, the confirmed credit CCi of the connection i is set to CCᵢ+CV, and the available credit ACᵢ of the connection i is set to ACᵢ+CV (S508).

Thereafter, it is determined whether CCᵢ of the connection i is equal to or larger than SPᵢ (S509). As the result of the determination at the step S509, if CCᵢ of the connection i is equal to or larger than SPᵢ, the HOL packet of the connection i is serviced, and BSᵢ is set to BSᵢ−SPᵢ and CCᵢ is set to CCᵢ−SPᵢ (S510). Thereafter, it is determined whether the packets of the connection i are present in the packet pool 33 (S512). If the queuing packets of the connection i are not present in the packet pool 33, CCᵢ and RSPᵢ are set to 0, ACᵢ is set to Wᵢ (S515), and then the process is terminated. On the contrary, if the queuing packets of the connection i are present in the packet pool 33, SPᵢ is set to the size of the HOL packet of the connection i (S514), and then the process returns to the step S509 (S514) to repeat the above procedure.

However, as the result of the determination at the step S509, if SPᵢ is larger than CCᵢ, the process proceeds to the next step S511, where it is determined whether RSPᵢ is 0. As the result of the determination at the step S511, if RSPᵢ is not 0, the process is terminated. On the contrary, as the result of the determination at the step S511, if RSPᵢ is 0, the process proceeds to the next step S513, where it is determined whether ACᵢ is equal to or larger than SPᵢ−CCᵢ. As the result of the determination at the step S513, if ACᵢ is equal to or larger than SPᵢ−CCᵢ, a credit value CV for service is set to min(Wᵢ, BSᵢ), RSPᵢ and RN are set to 0, ID is set to i, the token T<RN, CV, ID> corresponding to the set RN, CV, and ID is stored in the token queue 35 (S516), and the available credit ACᵢ of the connection i is reset to ACᵢ−CV (S518). Thereafter, the process is terminated. On the contrary, if it is determined at the step S513 that ACᵢ is smaller than SPᵢ−CCᵢ, a credit value CV for service is set to ACᵢ, RN is set to ┌(SPᵢ−CCᵢ−1)/Wᵢ┐, RSPᵢ is set to SPᵢ−CCᵢ−ACᵢ−(RN−1)Wᵢ, ID is set to i, the token T<RN, CV, ID> corresponding to the set RN, CV, and ID is stored in the token queue 35 (S517), and ACᵢ is reset to 0 (S519). Thereafter, the process is terminated. The purpose of the process described above is to prevent the occurrence of a token of credit smaller than the size of the HOL packet and Wᵢ.

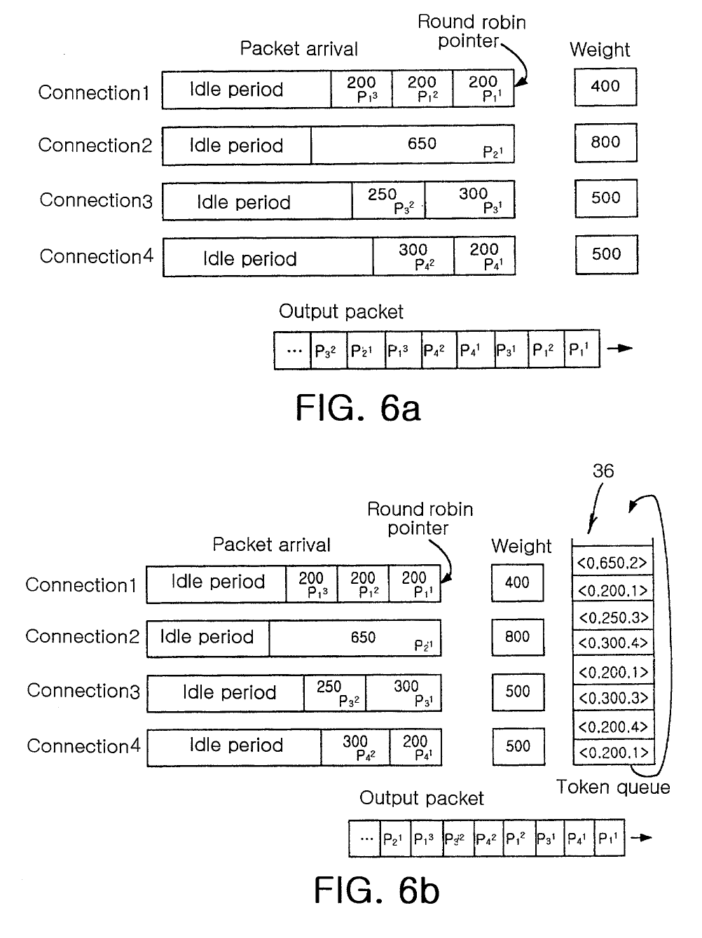

FIGS. 6a and 6b are views showing the comparison of the packet services, wherein FIG. 6a shows a conventional packet service according to a weighted round robin method, FIG. 6b shows a packet service of the scheduling apparatus according to the present invention.

In FIGS. 6a and 6b, it is assumed that four inputs are outputted to a single link and the bandwidth of each input stream is equal to that of an output stream. In addition, it is assumed that four connections arrive simultaneously and the packets have completely arrived when a single complete packet dependent on the size of the packet arrives, i.e., when a last byte arrives. As shown in FIGS. 6a and 6b, it is assumed that the weight credits W of the connections 1, 2, 3, and 4 are set as follows: W1=400, W2=800, W3=500, and W4=500. The packets arrive at the scheduler in the order of P₁¹=P₄¹>P₃¹>P₁²>P₄²>P₃²>P₁³>P₂¹.

As shown in FIG. 6a, in the conventional WRR method, the packets are serviced in the order of P₁¹>P₁²>P₃¹>P₄¹>P₄²>P₁³>P₂¹>P₃². However, as shown in FIG. 6b, for the round robin method of the present invention, the packets are serviced in the order of P₁¹>P₄¹>P₃¹>P₁²>P₄¹>P₃²>P₁³>P₂¹. However, in FIG. 6b, P₁¹ and P₄¹ arrive simultaneously and a connection nearer a progress direction of round robin pointer starts to be serviced. When the packets arrive, the token 36 is stored in the token queue 35 after the credit value CV is calculated using the available credit ACᵢ and the size of the packet SPᵢ, as described above with reference to FIG. 4. A HOL token of the stored tokens 36 start to be serviced. As described above, in FIG. 6b, packets are serviced in the same order as the packets arrive. If the packets arrive simultaneously, the packets of the nearer connection in the moving direction of the round robin pointer start to be serviced. Under the same conditions as the present invention, FIG. 6a represents that P₁² is first serviced although it arrives later than P₄¹ and P₃¹. Therefore, in FIG. 6a of the prior art, P₄¹ is serviced with a delay corresponding to the transmission time of P₁² and P₃¹, so the latency is increased.

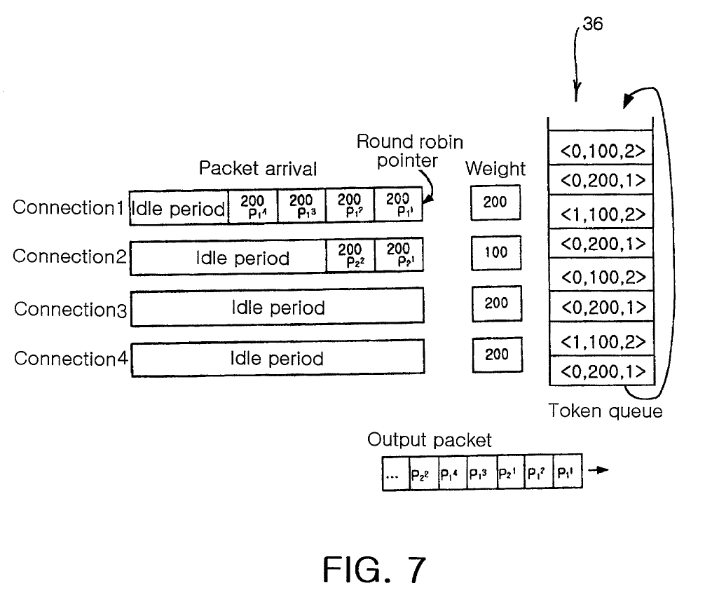

FIG. 7 is a view showing rate control based on weight credit in the scheduling apparatus of the present invention. As shown in FIG. 7, connections 1 and 2 represent that packets of the same size have arrived, while connections 3 and 4 represent that the packets have not arrived. The weight W1 of the connection 1 is 200 and the weight W2 of the connection 2 is 100. In this case, supposing that the bandwidth of all link are same, the arrival order of the packets is P₁¹=P₂¹>P₁²=P₂²>P₁³>P₁⁴. However, since the weights W1 and W2 are different from each other, the output order of the packets is P₁¹>P₁²>P₂¹>P₁³>P₁⁴>P₂². Since the weight W1 of the connection 1 is 200, CV is 200 at maximum. Accordingly, when a packet having the size of 200 such as P₁¹ arrives, the token 36 of T<0, 200, 1> is produced and stored in the token queue 35. Also, since the weight W2 of the connection 2 is 100, CV is 100 at maximum. Accordingly, when a packet having the size of 200 such as P₂¹ arrives, the token T<1, 100, 2> of the connection 2 is stored in the end of the token queue 35 and the token T<0, 100, 2> is stored and serviced in the next round. Here, since connection 2 should receive two tokens and service one packet, it is serviced at a half-one rate compared with connection 1. This is because the maximum credit value CV acceptable to the token 36 is equal to or less than the weight Wi. In the token queue 36, the token 36 as shown in FIG. 7 is produced, stored and serviced.

As described above, if an available credit is present when a packet arrives, then the size of the packet and credit as much as the available credit are carried on the token and transmitted to the token queue. If a connection backlogged at any time t is referred to as B(t), the sum T_CV of credits of the token stored in the token queue is expressed as follows:

$$T - CV \leq {\sum }_{i ∈ B ( t )} Min ( {W}_{i} , {BS}_{i} ) \qquad [ Equation 1 ]$$

When a packet Pᵢ^{j} of a new connection arrives, the credit value CV=Min[Wᵢ, SPᵢ^{j}] of the packet is carried on the token Ti and stored in the token queue. The token Tᵢ can be serviced after the T_CV is serviced. However, the packet is not outputted if the confirmed credit CCᵢ of a corresponding connection is smaller than the size of HOL packet SPᵢ of the corresponding connection even though the token is serviced from T_CV. Therefore, if a set of the connection to be serviced in the next round after the token of the new connection is stored in the token queue is referred to as SCₙ and round size is referred to as Fₙ, SCₙ, and Fₙ are respectively expressed as follows:

$${SC}_{n} \leq \{ i \vert ( {CC}_{i} + {W}_{i} ) \geq {SP}_{i} , {CC}_{i} < {SP}_{i} , ∀ i ∈ B ( t ) \} \qquad [ Equation 2 ]$$

In the above Equation, SCₙ represents that the packet is serviced in not (n−1)-th round but n-th round. Namely, SCₙ represents that CCᵢ<SPᵢ=<CCᵢ+Wᵢ. In addition, m represents the number of packets that associated with the connection to be serviced in current round. When Wᵢ is converged on 0, SCₙ and Fₙ are also converged on 0. When Wᵢ approaches 0, temporal distributions SC₁, SC₂ . . . , SCₙ of the set of the connection SC to be serviced are converged in a virtual finishing time order in a weight fair queuing (WFQ). Since SCₙ is equal to or less than a set of the connection with a virtual finishing time of the HOL packet of any connection i being between CCᵢ and CCᵢ+Wᵢ, SCₙ approaches fairness and latency characteristics of WFQ when Wi approaches 0. A round size Fₙ is equal to or less than the sum of the sizes of packets of the connection with the virtual finishing time being between CCᵢ and CCᵢ+Wᵢ in n-th round. Although the fairness and the latency are enhanced when W is set to a small value, as RN is increased and so the number of token is increased, it is required to consider and select the size of packet. According to this method, since weight W can be set proportional to a service rate for each connection unlike the prior round robin, the fairness and the latency can be enhanced for various sizes and rates of packets for a plurality of connections. In addition, since the time complexity is O(1), the method according to the present invention provides an easy expansion based on connection number, compared with the time stamp method.

As described above, the present invention provides a high-speed scheduler with time complexity of O(1) that is capable of enhancing the fairness and the latency for various sizes of packets and a plurality of connections over the prior round robin method. In addition, due to time complexity of O(1), the present invention is easily applicable to ATM switch, routers, communication terminals, etc., used in high-speed communication networks.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for packet scheduling using a credit based round robin in a high-speed communication network in which packets are transmitted to and received from a plurality of connections having allocated bandwidths of service, comprising:
a packet pool for storing input packets;
a token queue for storing tokens each having a connection identifier (ID) of an input packet stored in said packet pool, the round number (RN) of the connection, and a credit value (CV) for service; and
a connection management unit for transmitting the input packets to said packet pool, reading the packets stored in said packet pool, generating the tokens each having a connection identifier (ID) of an input packet stored in said packet pool, the round number (RN) of the connection, and a credit value (CV) for service and transmitting them to said token queue, and servicing the packets of said packet pool designated by the token stored in said token queue.

2. The apparatus according to claim 1, wherein said token queue is serviced in a first-in, first-out manner.

3. The apparatus according to claim 1, wherein said credit value (CV) for service, which is set on said token, is a HOL packet credit value of said token queue.

4. The apparatus according to claim 1, wherein said connection management unit sets weight W for each connection and sets said weight W as an available credit AC; produces and transmits to said token queue a token having a corresponding connection identifier (ID), the round number (RN) of the connection, and the credit value (CV) of the size of the packet if a packet of a size less than said set available credit (AC) arrives; produces and transmits to said token queue a token having a corresponding connection identifier (ID), the round number (RN) of the connection, and the available credit (AC) as the credit value (CV) if the packet of a size larger than said set available credit (AC) arrives and a difference between the size of the packet and the available credit AC is less than the weight (W); and produces and transmits to said token queue a token having a corresponding connection identifier (ID), the round number (RN) of the connection, and the weight (W) as the credit value (CV) if the packet of a size larger than said set available credit (AC) arrives and a difference between the size of the packet and the available credit (AC) is larger than the weight (W).

5. The apparatus according to claim 4, wherein the available credit (AC) is reset to {the available credit (AC)−the size of the packet} and the round number (RN) is reset to 0 if the packet of a size equal to or less than said set available credit (AC) arrives; and the residual size of HOL packet (RSP) is reset to {the size of the packet−the available credit (AC)}, the round number (RN) is set to 1 and then the available credit (AC) is reset to 0 if the packet of a size larger than said set available credit (AC) arrives and a difference between the size of the packet and the available credit AC is equal to or less than the weight (W); and the round number (RN) is reset to ┌{the size of the packet−the available credit (AC)−1}/the weight (W)┐, the residual size of HOL packet (RSP) is reset to {(the size of the packet−the available credit (AC)−(the round number (RN)−1)×the weight (W)} and then the available credit (AC) is reset to 0 if the packet of a size larger than said set available credit (AC) arrives and a difference between the size of the packet and the available credit (AC) is larger than the weight (W).

6. The apparatus according to claim 1, wherein the token is not produced and the next tokens wait to be added, if the available credit (AC) is less than the weight (W) and the size of the HOL packet (SP).

7. The apparatus according to claim 1, wherein said connection management unit manages parameters of a connection identifier (ID), a weight (W), an available credit (AC), the size of HOL packet (SP), a confirmed credit (CC), a backlog size of the packet (BS), and the residual size of the packet (RSP).

8. The apparatus according to claim 1, wherein said connection management unit has at least one token for the same connection and services the packets in the order of arrival in a range of the available credit (AC).

9. A method for packet scheduling using a credit based round robin in a high-speed communication network for receiving a plurality of packets arrived at a network switch from a plurality of the connection having a respective service rate and transmitting the packets to a communication link, comprising:
a first step of setting weight (W) proportional to a service rate for each of the connections and setting said weight as available credit (AC);
a second step of receiving and storing at least one input packet;
a third step of generating a token having a connection identifier (ID) of the input packet of the connection, round number (RN) of the connection and a credit value (CV) for service, according to the result of the comparison of the size (SP) of the received input packets with the size of the available credit (AC) and storing the token in a token queue if the residual size (RSP) of a HOL packet of each connection stored is 0; and
a fourth step of servicing the stored packet designated by the token stored in the token queue.

10. The method according to claim 9, wherein said token queue is serviced in a first-in, first-out manner.

11. The method according to claim 9, wherein said third step comprises:
a fifth step of determining whether the available credit (AC) is equal to or larger than the size of the input packet (SP);
a sixth step of setting the credit value (CV) of a corresponding connection to the size of the packet (SP), setting the round number (RN) to 0 so that the corresponding connection is set, and resetting the available credit (AC) to (the AC−the SP), if the available credit (AC) is equal to or larger than the size of input packet (SP) as the result of the determination at said fifth step;
a seventh step of comparing a value (SP−AC) derived by subtraction of the available credit (AC) from the size of the packet (SP) with the weight (W), if the available credit (AC) is less than the size of input packet (SP) as the result of the determination at said fifth step;
an eighth step of setting the credit value (CV) of a corresponding connection to the available credit (AC), setting the round number (RN) to 1 so that the token of the corresponding connection is set, and setting the value of (SP−AC) to the residual size of the packet (RSP), if the value of (SP−AC) is equal to or less than the weight (W) as the result of the comparison at said seventh step; and
a ninth step of setting the credit value (CV) of the corresponding connection to the available credit (AC) and setting the round number (RN) to ┌(the SP−the AC−1)/the W┐ so that the token of the corresponding connection is set and resetting the residual size of the packet (RSP) to {the SP−the AC−(the RN−1)×the W}, if the value of (SP−AC) is larger than the weight (W) as the result of the comparison at said seventh step.

12. The method according to claim 11, wherein parameters of a connection identifier (ID), a weight (W), an available credit (AC), the size of the HOL packet (SP), a confirmed credit (CC), a backlog size of the packet (BS) and the residual size of the packet (RSP) are managed for each connection and reset based on the size of input packets (SP).

13. The method according to claim 11, wherein, tokens next to current token wait for inputted tokens having credits less than the weight (W) and are added without immediate setting of the current token, if the size of the packets (SP) is less than the confirmed credit (CC) at the time of receiving and outputting the packets and the residual size of HOL packet (RSP) is larger than 0.

14. The method according to claim 9, wherein, if at least one token is set for the same connection, the packets are serviced in the order of arrival in a range of the available credit (AC).

15. The method according to claim 9, wherein, at said fourth step, the HOL packet of a corresponding connection designated by a HOL token is serviced.

16. The method according to claim 9, wherein said third step further comprises:
a tenth step of servicing the HOL packet, if the size of the HOL packet of the stored input packets is equal to or less than the credit value (CV) set in the HOL token, and otherwise adding the credit value (CV) to a confirmed credit (CC) and storing credit amounting to the available credit (AC) in the token queue again; and
an eleventh step of assigning the available credit (AC) of a required amount and storing the token of the corresponding connection in the token queue, if the backlogged packet (BS) of the corresponding connection is present or a new packet arrives after the HOL packet is serviced.

17. The method according to claim 9, wherein the round number (RN) is set to (RN−1) and stored in the token queue if the round number (RN) of the HOL token is larger than 1 at the time of outputting the packets, RN is set to 0 and CV is set to a smaller one of the weight (W) and the backlog size (BS) and stored in the token queue if RN is equal to 1, and a confirmed credit (CC) is compared with the size of the HOL packet and serviced if RN is equal to 0.

18. A computer readable recording medium in which a program is recorded for executing a method for packet scheduling using a credit based round robin in a high-speed communication network in which packets are transmitted to and received from a plurality of connections having allocated service rates, comprising:
a first step of setting weight (W) proportional to a service rate for each of the connections and setting said weight as available credit (AC);
a second step of receiving and storing at least one input packet;
a third step of generating a token having a connection identifier (ID) of the input packet of the connection, a round number (RN) of the connection and a credit value (CV) for service, according to the result of the comparison of the size (SP) of the received input packets with the size of the available credit (AC) and storing the token in a token queue if the residual size (RSP) of a HOL packet of each connection stored is 0; and
a fourth step of servicing the stored packet designated by the token stored in the token queue.
